(19) United States
(12) Patent Application Publication
(10) Pub. No.: US 2023/0211630 A1
(43) Pub. Date: Jul. 6, 2023

(54) PAINT BUCKET DISPENSING AND DRIPLESS STORAGE SYSTEM

(71) Applicant: John Patrick O'Brien, Camarillo, CA (US)

(72) Inventor: John Patrick O'Brien, Camarillo, CA (US)

(21) Appl. No.: 18/092,771

(22) Filed: Jan. 3, 2023

Related U.S. Application Data
(60) Provisional application No. 63/296,646, filed on Jan. 5, 2022.

(51) Int. Cl. B44D 3/12; B65D 25/48; B44D 3/00

(52) U.S. Cl. CPC B44D 3/127; B65D 25/48; B44D 3/006

(57) ABSTRACT

A paint bucket dispensing and dripless storage system includes a lid detachably connected to a paint bucket having a port formed therethrough. A paint dispenser extends through the lid port in sealed relation and defines a paint fluid pathway between an intake end within the bucket and an outlet end extending above the lid. The paint outlet is configured to be detachably connected to a hose of an airless paint sprayer. An upper assembly of the paint dispenser is detachably coupled to a lower assembly of the paint dispenser, such as by a manually actuated quick connect/disconnect mechanism.

### RELATED APPLICATION

This application claims the benefit of U.S. Provisional Application No. 63/296,646, filed on Jan. 5, 2022.

### FIELD OF THE INVENTION

The present invention generally relates to liquid containers, such as paint buckets for use with airless sprayers. More particularly, the present invention relates to a paint bucket dripless lid storage and airless spray dispensing system.

### BACKGROUND OF THE INVENTION

Paint contractors often obtain paint, and other materials, in five-gallon buckets. The bucket comes sealed with a plastic lid and has a metal handle with a small plastic grip. The five-gallon buckets are large enough to hold a sufficient amount of paint, or other material, so as to not be quickly exhausted, but are also of a weight which can be carried by a worker. It is also well known that five-gallon buckets are used to store and offer a variety of materials other than paint.

A top or lid that comes with a conventional five-gallon bucket, particularly that containing paint, is very difficult to manually pry off of the top rim. It can take a significant amount of exertion using one's fingers and hands to remove the lid. In fact, a tool is offered which assists in taking the top lid off of the bucket. Workers must carry the tool in order to easily remove the conventional lids from the five-gallon buckets. However, if the tool falls out of their pocket, they forget it, or even lose it, they are forced once again to remove the lid from the top of the bucket with their hands, which can create injuries over time. Moreover, it is frustrating for the workers and can take a significant amount of time in order for the workers to remove the conventional lids.

As mentioned above, these five-gallon buckets come with a handle, in the form of a bent metal rod which extends from both sides of the bucket to a central portion where a small plastic sleeve overlies the metal rod and serves as a grip for the handle. However, the grip is relatively small and lifting the heavy bucket full of paint can create finger pressure and stress and fatigue the fingers and hands of the workers, particularly over time as the buckets are carried from one location to another. This can create tension, stress, and fatigue not only to the fingers and hand, but to the arm and entire upper body. This can create injuries to the workers over time.

Contractors and/or commercial painters often purchase material, such as paint and the like, in five-gallon buckets. In the case of paint, they often use an airless sprayer to dispense the paint from the bucket to the house or other object being painted. Using one-gallon metal buckets is not efficient as the commercial painter will go through a relatively large volume rather quickly, necessitating the purchasing and opening of five times as many metal gallon buckets.

However, in the case of the conventional five-gallon buckets, problems persist, such as removing the lid from the bucket, sometimes without the use of the tool. A hose extends from the airless sprayer into the five-gallon bucket, in order to dispense the paint. One problem with completely removing the lid is that if the bucket needs to be moved the paint can slosh and spill from the bucket, creating a mess, possibly damaging areas and losing paint unnecessarily. To avoid these issues, the painters will typically cut a V-shaped hole in the top lid of the bucket and insert the feed hose line from the airless dispenser in it. Thus, when the bucket is moved a smaller opening is presented and the sloshing of the paint will not spill as much paint from the bucket. Problems arise, however, when they must store the paint, such as going to lunch, away for the night, weekend or the like. The opening in the top lid will expose the paint to air, causing it to dry and become ineffective for painting. The workers typically will put rags over the top of the lid as a stop-gap measure. However, in some cases, the aforementioned problems will still present themselves.

Accordingly, there is a continuing need for improvements with conventional five-gallon buckets, including improved lids which seal the contents of the five-gallon container but are more easily manually removed and installed and provide access to the contents of the bucket. An improved handle is also needed which lessens the tension and is more ergonomic in nature, and which can be used with enlarged lids. What is also needed is an improved system for dispensing the paint or other material from the five-gallon bucket, such as when using airless sprayers or the like. The present invention fulfills these needs and provides other related advantages.

### SUMMARY OF THE INVENTION

The present invention resides in a paint bucket dispensing and dripless storage system. The system of the present invention facilitates dispensing of paint, or other fluid, from a bucket and also provides for easier access to the bucket, and dripless airtight storage. The system of the present invention also provides improvements in the handle, lid and the bucket.

The paint bucket dispensing and dripless storage system of the present invention generally comprises a lid detachably connected to a paint bucket. The lid has an aperture formed therethrough. A paint dispenser extends through the lid aperture in sealed relation thereto, such that a paint intake end of the paint dispenser is disposed within the bucket and a paint outlet end is disposed above the lid. The paint dispenser defines a paint fluid pathway between the intake end and the outlet end. The paint outlet end is configured to be detachably connected to an inlet tube of an airless paint sprayer.

The paint dispenser typically comprises an upper assembly residing above the lid and including the paint outlet end, and a lower assembly which includes the paint intake end. The upper and lower assemblies are preferably detachably coupled to one another. The upper assembly is preferably detachably coupled to the lower assembly by a manually actuated quick connect/disconnect mechanism.

The quick connect/disconnect mechanism may comprise a bayonet fitting cooperatively defined by portions of the upper and lower assemblies. Alternatively, the quick connect/disconnect mechanism may comprise a push lock mechanism defined by portions of the upper and lower assemblies. The push lock mechanism may comprise locking members moved into a locked position when the upper assembly is pushed into the lower assembly and moved into an unlocked position when the upper assembly is pulled away from the lower assembly.

A valve is disposed in the lower assembly and biased towards a closed position when the upper assembly is detached from the lower assembly to close the paint fluid pathway and prevent paint from leaking from the lower assembly and the paint bucket. The upper assembly moves the valve into an open position, so as to open the paint fluid pathway, when the upper assembly is coupled to the lower assembly.

The lid may include a living hinge that enables a portion of the lid to be selectively opened and closed while the lid is attached to the paint bucket.

The lid may also extend outwardly a distance from an upper edge of the bucket and defined one or more fingerhold areas.

The system may include an enlarged, ergonomic handle detachably connected to the bucket.

A cleaning adapter is connectable to at least a portion of the paint dispenser to enable a cleaning fluid to pass through the cleaning adapter and the paint fluid pathway of the paint dispenser to dislodge clogs or clean the paint fluid pathway and paint dispenser.

The paint bucket may include recessed handholds formed in a lower portion thereof.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of a paint bucket dispensing and dripless storage system embodying the present invention;

FIG. 2 is a side view of the system of FIG. 1;

FIG. 3 is a top view of the system of FIG. 1;

FIG. 4 is an exploded perspective view of the various components of the system of FIG. 1;

FIGS. 5A and 5B are perspective views illustrating an upper assembly of a pain dispenser of the system of the present invention being attached to a lower assembly of the paint dispenser, in accordance with an embodiment of the present invention;

FIG. 6 is a top perspective view of a lid used in accordance with the present invention;

FIG. 7 is a bottom perspective view of the lid of FIG. 6;

FIG. 8 is a partial perspective view illustrating the upper assembly of the paint dispenser in position to be attached to the lower assembly of the paint dispenser extending through an aperture of the lid;

FIG. 9 is a top plan view illustrating the attachment of the upper assembly to the lower assembly of the paint dispenser;

FIG. 10 is a partial cross-sectional view illustrating the attachment of the upper and lower assemblies of the paint dispenser, extending through a lid of the system of the present invention;

FIG. 11 is a cross-sectional view of the system of FIG. 3;

FIG. 12 is another cross-sectional view of the system of FIG. 3;

FIG. 13 is a top perspective view of a universal use lid having a living hinge, in accordance with the present invention in a closed position;

FIG. 14 is a perspective view of the lid attached to a bucket and in the open position;

FIG. 15 is a view similar to FIG. 14;

FIG. 16 is a side view illustrating movement of the lid from a closed position to an open position;

FIG. 17 is a cross-sectional view of the lid of FIG. 13;

FIG. 18 is an enlarged view of area “18”, illustrating the particulars of the living hinge of the lid;

FIG. 19 is a top perspective view of a lid that can be used in accordance with the present invention;

FIG. 20 is a bottom perspective view of the lid of FIG. 19;

FIG. 21 is a partial side perspective view of a handle attached to a bucket, in accordance with the present invention;

FIG. 22 is a cross-sectional view of an ergonomic handle used in the system of the present invention;

FIGS. 23A and 23B are perspective views of a handle adapter being attached to a bucket, in accordance with the present invention;

FIG. 24 is a cross-sectional view illustrating the handle adapter interconnected between the bucket and a handle;

FIG. 25 is a bottom perspective view of the handle attached to the bucket, in accordance with the present invention;

FIG. 26 is a perspective view of another adapter interconnected to a bucket and the handle, in accordance with the present invention;.

FIG. 27 is a perspective view of components comprising the adapter of FIG. 26;

FIG. 28 is a cross-sectional view of a bucket having recessed handholds, in accordance with the present invention;

FIG. 29 is a side perspective view of a paint bucket dispensing and dripless storage system of the present invention;

FIG. 30 is a top perspective view of the system of FIG. 29, illustrating an upper assembly detached from a lower assembly of the paint dispenser, and having an inlet tube of an airless paint sprayer attached thereto, in accordance with the present invention;

FIG. 31 is an exploded perspective view of the component parts of the system of FIG. 29;

FIG. 32 is a cross-sectional view of the assembled system of FIG. 29; and

FIG. 33 is an exploded perspective view illustrating a cleaning adapter attachable to a portion of the paint dispenser, in accordance with the present invention.

### DETAILED DESCRIPTION OF THE PREFERRED EMBODIMENTS

As shown in the accompanying drawings, for purposes of illustration, the present invention is directed to an airless spray paint bucket attachment and dispensing system. As will be more fully described herein, the invention provides a quick-release detachable valve component for easily connecting the airless sprayer to different buckets of paint, or other fluid, which incorporate the present invention.

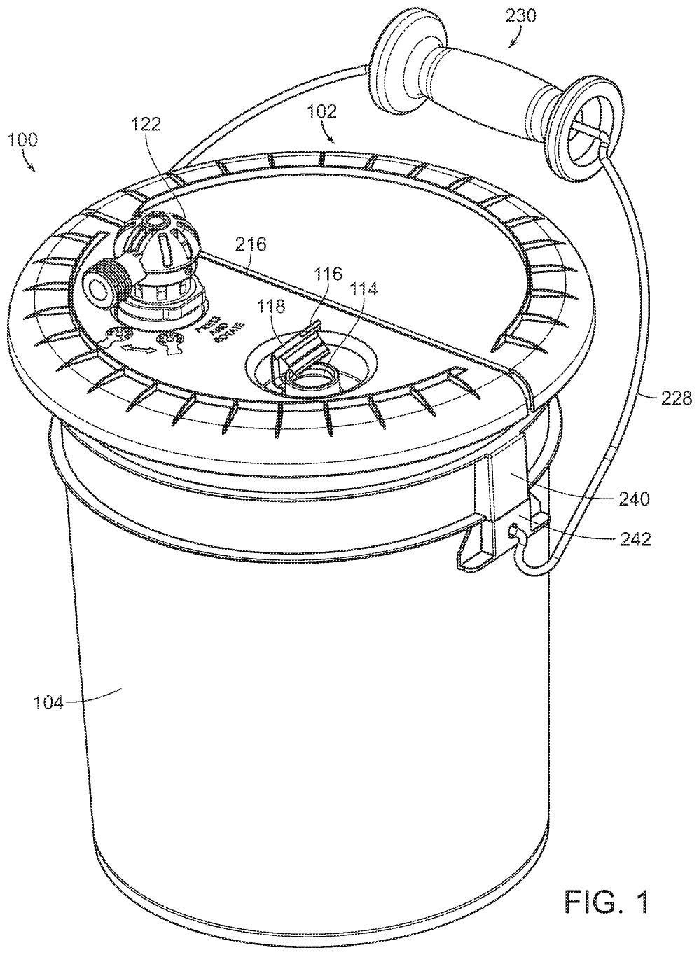

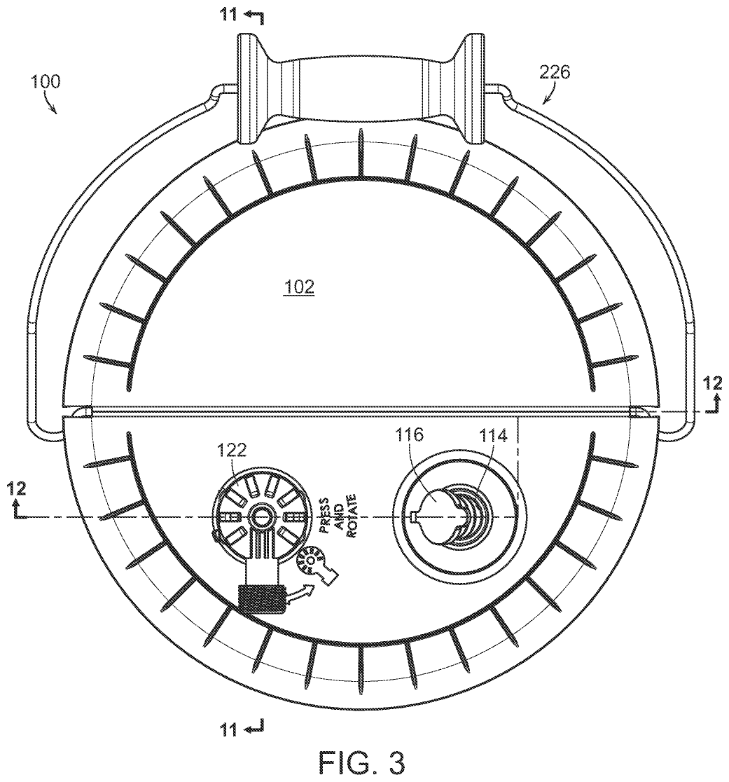

With reference now to FIGS. 1-3, the system 100 of the present invention, includes a lid 102 which is detachably connected to a paint bucket 104. Typically, the paint bucket 104 is a five-gallon paint bucket, although it will be appreciated that the paint bucket may be of differing sizes. Moreover, while the present invention is particularly suited for use as a paint delivery system, such as in conjunction with an airless sprayer, other fluids could be within the bucket and dispensed using the present invention, such as stains or other fluids. Thus, the term “paint” can be interpreted to include not only paint, but also other fluids, including stains and the like.

The bucket 104 may be a preexisting bucket having the paint therein, to which the present invention is attached to. Alternatively, as described above, the present invention may provide a modified and improved paint bucket for use in conjunction with the system of the present invention.

The lid has an aperture 106 formed therethrough which forms a port to which a paint dispenser 108 of the present invention extends through in sealed relation. This port has a molded cylindrical sleeve or skirt to which the paint dispenser 108 is attached. The paint dispenser 108 has a paint intake end 110 and a paint outlet end 112. The inlet end 110 is disposed within the bucket 104, and the outlet end 112 is disposed above the lid 102. A paint fluid pathway is formed between the intake end 110 and the outlet end 112 when the paint dispenser assembly 108 is fully assembled. The paint outlet end 112 is configured to be detachably connected to an inlet tube or fitting of an airless paint sprayer.

The lid 102 may also include a second aperture 114 forming a return port which provides access to the interior of the bucket 104 and can be used, for example, for a return line or a purge line or the like of the airless sprayer to be inserted therein for returning purged or otherwise unused paint back into the bucket 104. The port 114 may also be a molded cylindrical member and may have a plug 116 associated therewith for sealingly plugging the port 114. The plug 116 may be attached to the port 114, such as by a strap 118. In this manner, when not in use, the port 114 may be plugged and sealed to form an airtight connection.

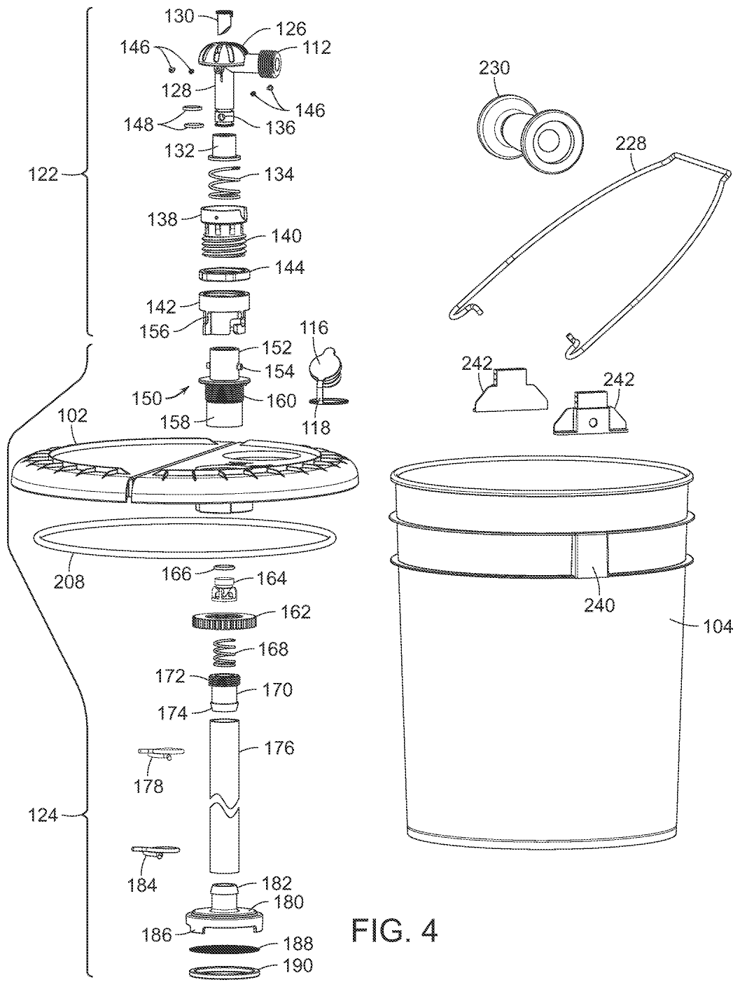

With reference now to FIG. 4, an exploded view of the various component parts of the system 100 of the present invention is shown. The components of the paint dispenser 108 are illustrated exploded apart from one another above and below the lid 102 and gasket 120 of the lid. In a particularly preferred embodiment, the paint dispenser 108 includes an upper assembly 122 which is detachably coupled with a lower assembly, which resides within and/or below the lid 102. The upper assembly 122 is detachably connected to the lower assembly 124 by a manually actuated quick connect/disconnect mechanism, such that the upper assembly 122 can be quickly and easily manually disconnected from the lower assembly 124 of the paint dispenser 108 when changing paint buckets, for storage purposes, etc.

The upper assembly 122 includes the paint dispenser outlet end 112, which is configured for attachment or coupling to a tube of the airless sprayer. As such, the end 112 typically includes external threads, as illustrated.

This extends from a hose adapter 126 having a hollow shaft 128 extending therefrom, typically at a generally transverse angle to the open end 112. For manufacturing purposes, a plug 130 may be inserted into an open top of the hose adapter 126, such that the paint or other fluid is directed through the shaft 128 and out the open outlet end 112.

The hollow shaft 128 of the hose adapter 126 extends through a bushing 132 which is biased by a compression spring 134 such that the bushing 132 covers inlets 136 when the upper assembly 122 is detached from the paint dispenser assembly 108. The spring 134 rests within a hose adapter body 138 having external threads 140 which are threaded into a hose adapter bayonet 142. A jam nut 144 may connect the hose adapter body 138 and hose adapter bayonet 142. Fasteners 146, such as threaded inserts and/or screws or the like may attach the shaft 128 of the hose adapter 126 to the hose adapter body 138, as needed. O-rings 148 may be disposed on either side of the shaft inlet apertures 136 to seal the shaft 128 and the bushing 132 to provide a dripless connection therebetween.

The lower assembly 124 includes a lid adapter body 150 including an upper shaft 152 having one or more projections 154 extending therefrom for insertion into open ended track 156 of the hose adapter bayonet, so as to form a bayonet fitting. A lower shaft 158 of the lid adapter body 150 includes threads 160 for attachment to either internal threads formed in the aperture port 106 of the lid 102, or more typically to tightening nut 162. A lid adapter valve 164 includes a sealing O-ring 166 attached thereto and is biased by spring 168 upwardly into the lid adapter body 150 for sealing engagement therewith when the upper assembly 122 is detached from the lower assembly 124. A lid adapter fitting 170 has external threads 172 at an upper end thereof which are threadedly engaged with internal threads of a lower portion of the shaft 158 of the lid adapter body 150, so as to be attached thereto, and a lower barbed portion 174, which comprises a beveled ramp, for attachment of a feed line hose 176. A tension spring 178 may be used to connect an end of hose 176 to the lid adapter fitting 170, at one end thereof.

A filter fitting 180 is attached to a generally opposite end of the hose 176, and may include a barb section 182, such as comprising a beveled or ramped end, that the end of the hose 176 can be attached to. Tension spring 184 may connect the end of the hose 176 to the filter fitting 180. The filter fitting 180 preferably includes legs 186, so as to provide a space between the filter fitting 180 and the bottom surface of the bucket, so as to enable paint or other liquid to be drawn into the filter fitting 180 and through the tubing 176. The filter fitting 180 may include a mesh filter 188 and a mesh filter cover 190 so as to filter the paint or other fluid which passes therethrough.

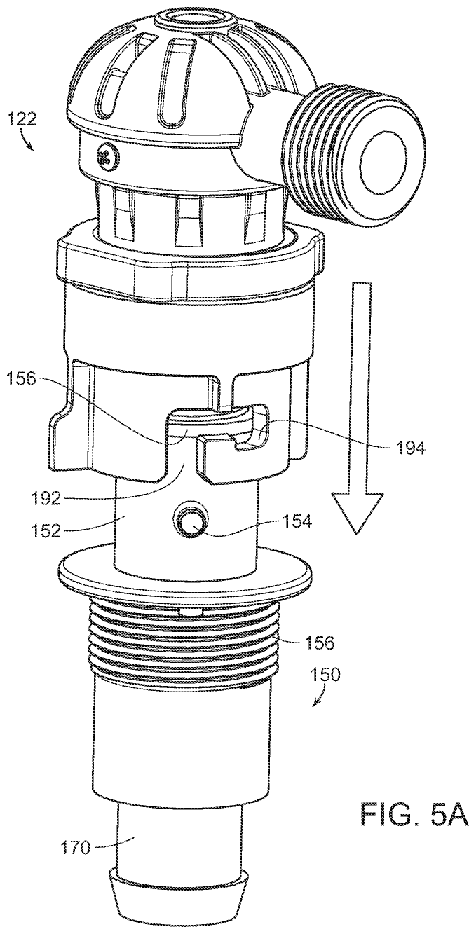

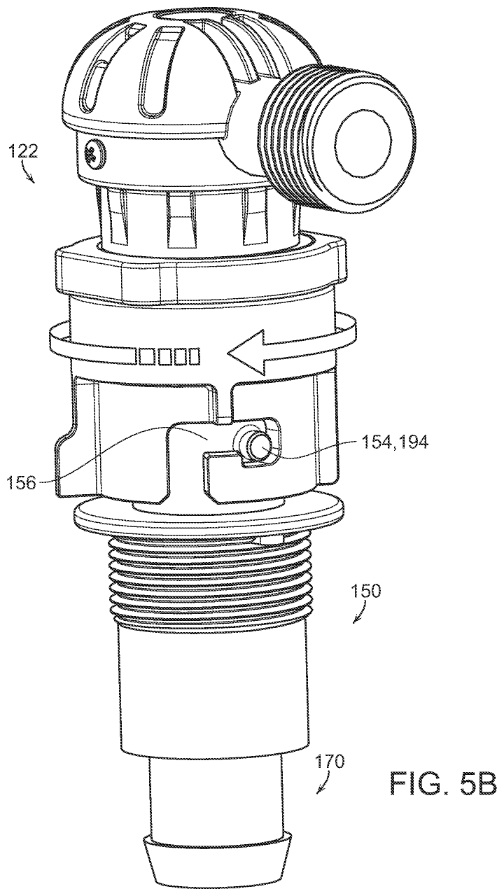

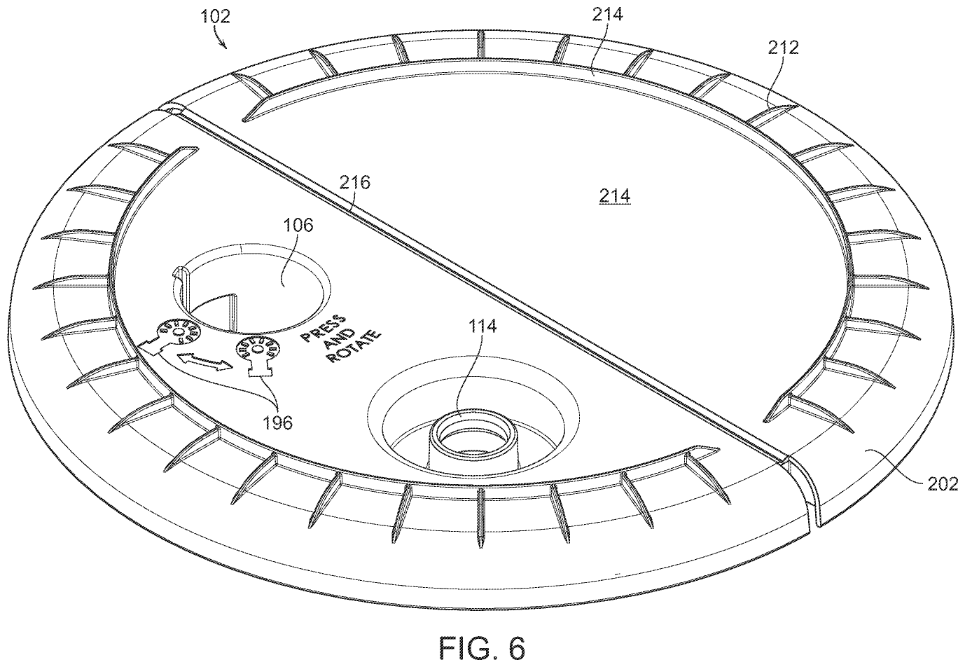

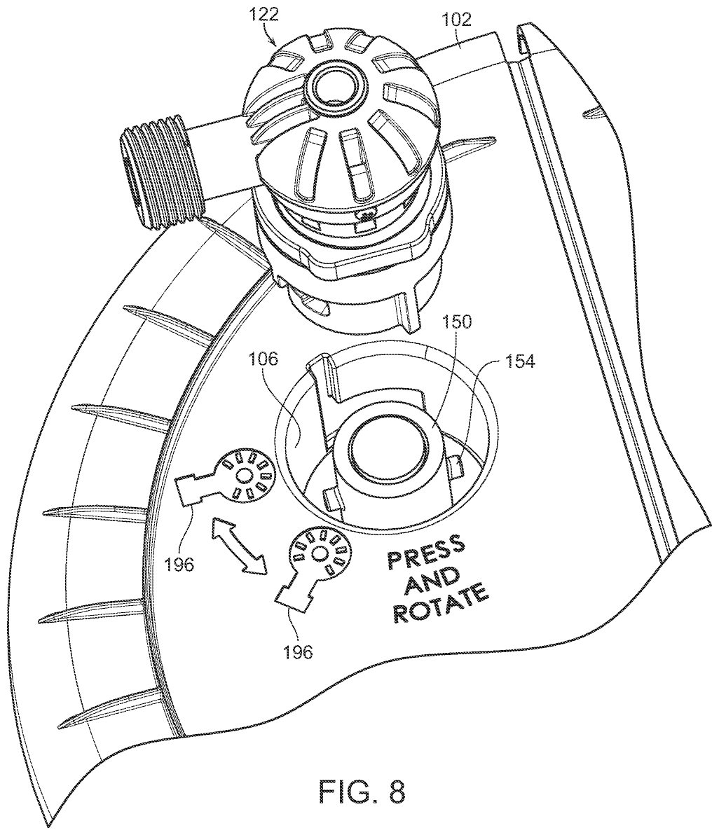

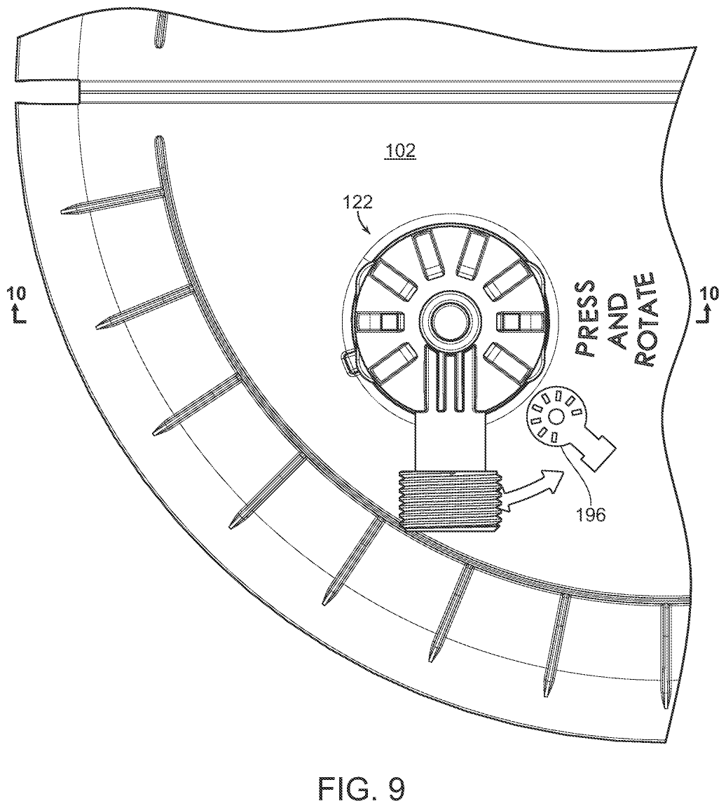

With reference now to FIGS. 5A and 5B, as mentioned above, in a particularly preferred embodiment, the upper assembly 122 is detachably connected to the lower assembly 124, such as a quick-release attachment or removal. As illustrated in FIG. 5, the quick connect/disconnect mechanism comprises a bayonet fitting cooperatively defined by portions of the upper and lower assemblies. More particularly, the lower lid adapter 150, of the lower assembly 124, includes protrusions 154 extending therefrom which are insertable into an open end 192 of the track 156 as the upper assembly 122 is pushed downwardly onto the lid adapter body 150, as illustrated in FIG. 5A. Upon twisting the upper assembly 122, as illustrated in FIG. 5B, the protrusion 154 travels the track to the closed end 194 of the track, wherein the upper assembly 122 is in locked position to the lower assembly 124 given the generally L or Z configuration of the open ended track 156. It will be understood that typically the lid adapter body 150 is attached to the lid, such as by nut 162, so as to reside within the typically recessed aperture or port 106 of the lid 102. Thus, when the upper assembly 122 is coupled or decoupled from the lid adapter body 150, and thus the lower assembly 124, this is typically done when the lower assembly 124 is attached to and extends downwardly from the lid 102. As illustrated in FIG. 6, the lid 102 may include indicia 196 which illustrates and describes how to connect or detach the upper assembly 122 to the lower assembly 124, as illustrated in FIGS. 8 and 9.

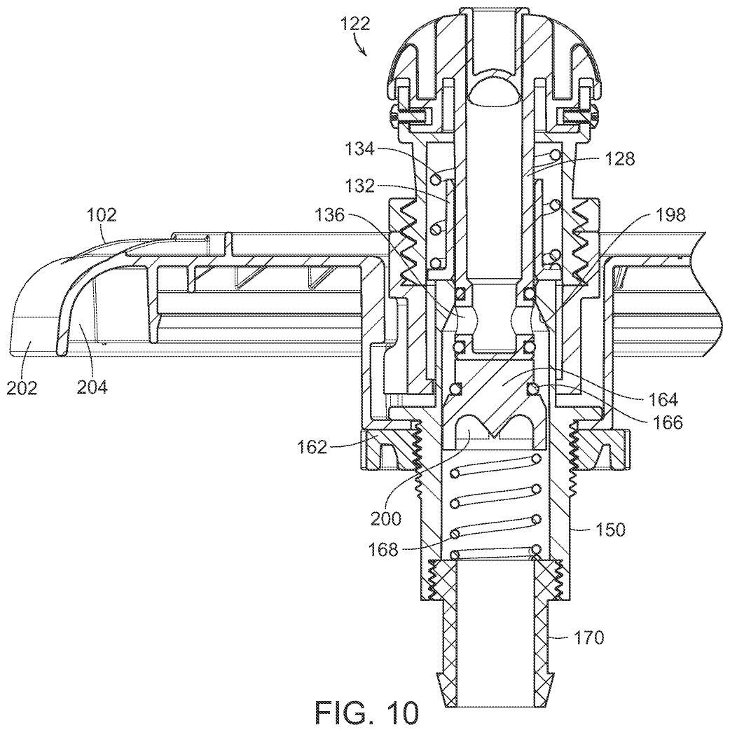

With reference now to FIG. 10, which is a cross-sectional view taken generally along 10-10 of FIG. 9, the upper assembly 124 connected to the upper portion of the lower assembly is shown. When the upper assembly 122 is coupled to the lower assembly, as illustrated in FIG. 10, bushing 132 is moved against the bias of spring 134 so as to expose inlets 136 of the hollow shaft 128. Moreover, insertion of the shaft 128 of the upper assembly 122 into the lower assembly 124 causes the lid adapter valve 164, and its sealing O-ring 166 to be pushed downwardly away from internal ramped portion 198 of the lid adapter body 150 and thus into an open position so as to allow the paint to flow through openings 200 of the valve 164 and to the inlets 136 of shaft 128 so as to pass through the upper assembly 122 to the outlet 112.

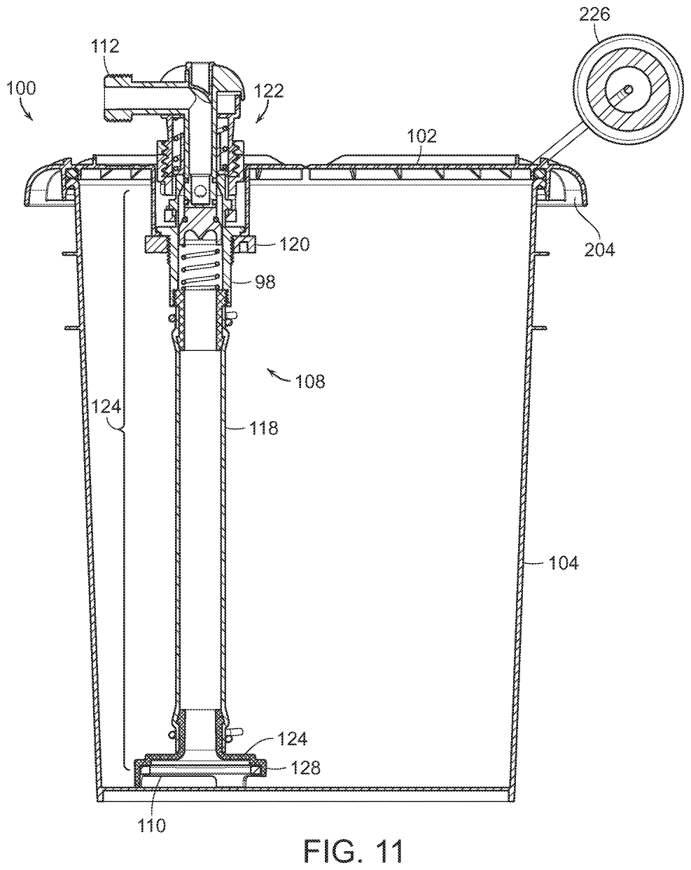

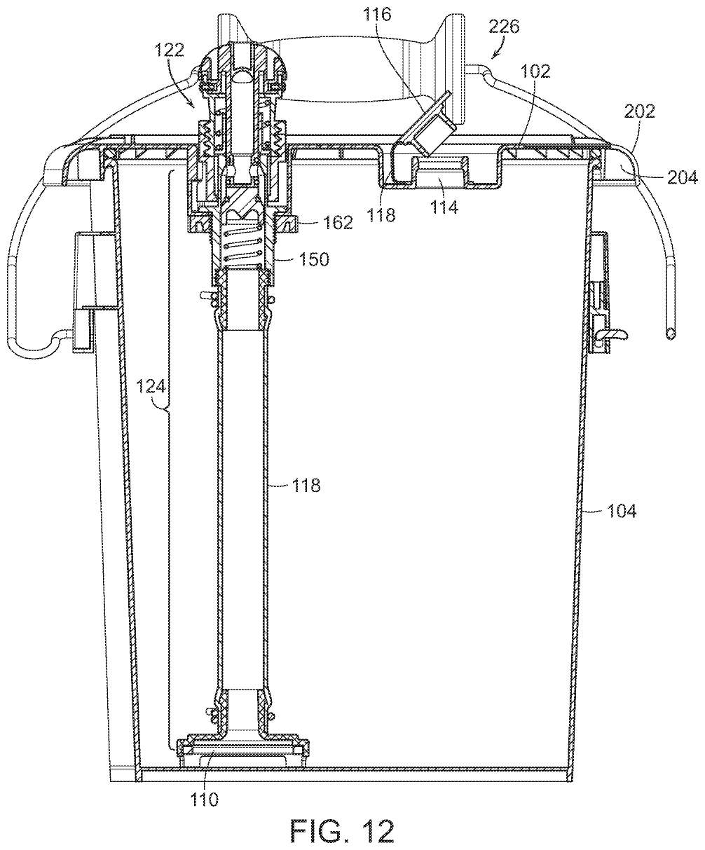

However, when the upper assembly 122 is decoupled and removed from the lower assembly 124, bushing 132 is then biased downwardly so as to cover inlets 136. Spring 168 biases the valve 164 into its closed and seated position against the internal ramp section 198 such that the gasket 166 seals against the ramp 198 so as to seal the fluid pathway of the lower assembly 124 and prevent paint or other fluid from passing therethrough. As the lid adapter body 150 is tightly attached to the port 106, such as by nut 162, a watertight, sealed connection is formed between the lower assembly 124 and the lid 102, preventing paint or other fluid from passing therethrough when the upper assembly 122 is removed therefrom. Thus, no paint or other fluid will drip from either the upper assembly 122 or from the lower assembly 124 or lid 102, and thus the paint bucket, when the upper assembly 122 is detached from the lower assembly 124. However, when the upper assembly 122 is connected to the lower assembly 124, as illustrated in FIG. 10, a fluid flow pathway is created between the inlet end 110 of the paint dispenser assembly 108, comprising the upper and lower assemblies 122 and 124, enabling paint to flow from the inlet end 110 through the dispenser 108 and out outlet 112, such as when being suctioned by the attached airless sprayer, as illustrated in FIGS. 11 and 12.

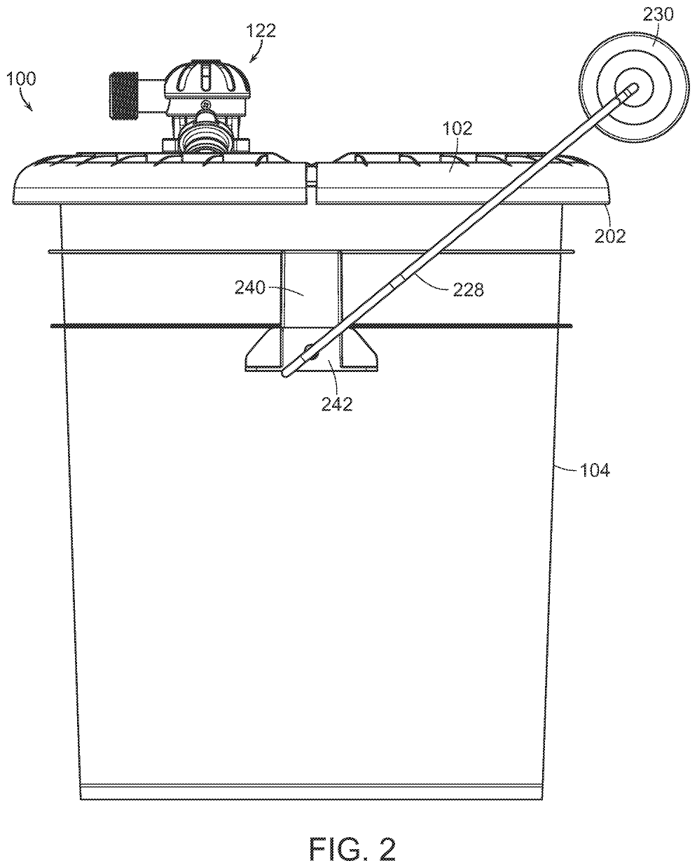

As shown in FIGS. 1 and 2, the lid 102 is of a diameter such that a peripheral edge 204 thereof extends beyond an upper lip of the bucket 104.

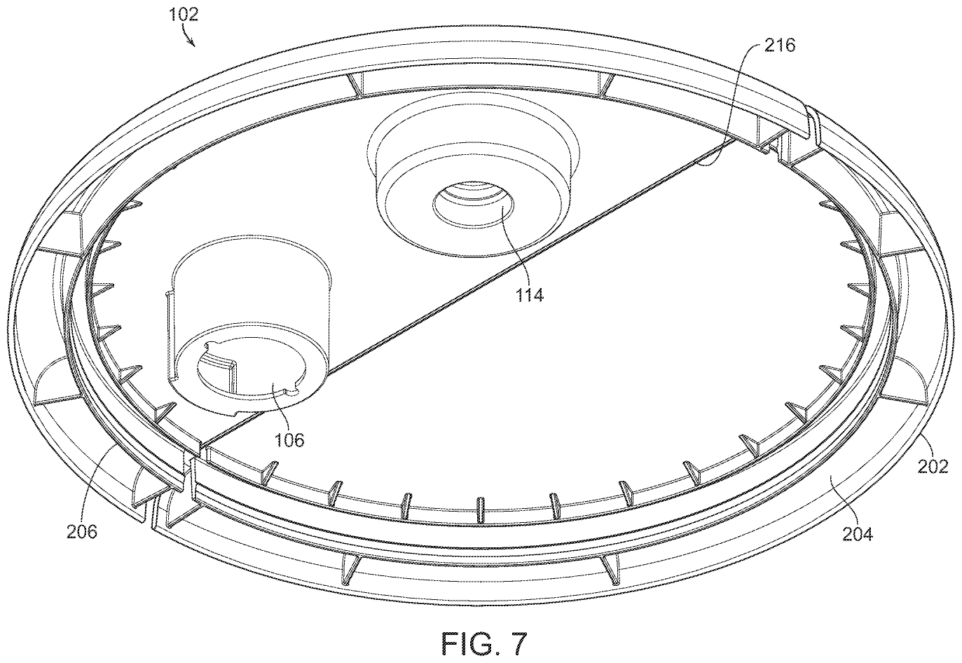

As shown in the various figures, including FIG. 10, the outer edge of the lid 202 is preferably of a curved configuration. On the under side of the lid 202, as illustrated in FIGS. 7 and 10, are recessed so as to form ergonomically-shaped fingerholds 204 which are sized and configured to enable a user to insert his or her fingers into the fingerholds 204 to facilitate the removal of the lid 102 from the bucket 104. The fingerholds 204 are recessed and extend from the outer edge 202 to an inner edge or lip 206, which typically engages an outer surface of the upper rim of the bucket 104. The fingerholds 204 are formed by a recessed area or open-groove. This may extend substantially along the periphery of the underside of the lid 102 so as to enable the user to insert his or her fingers at nearly any position along the underside of the lid 102 and easily pry the lid 102 from the bucket 104.

As illustrated in FIG. 4, a gasket or O-ring or the like 208 may be provided so as to create a sealingly engageable surface between the lid 102 and an upper rim of the bucket 104. In this manner, when the lid 102 is disposed on top of the bucket, the paint or other liquid within the bucket 104 is sealed and will not spill and can be stored for periods of time without drying out. Instead, a tight frictional fit may be formed between the inner lip 206 and the upper rim of the bucket to achieve the same purposes.

The lid 102 preferably includes a plurality of spaced apart ribs 212 which provide structural support to the lid 102. These ribs 212 are formed in a radial pattern, as illustrated. A crown 214 in the form of a raised lip extends upwardly from a top surface 214 of the lid 102. The crown 214 is of a dimension which is slightly greater in diameter than a bottom diameter of the bucket, such as a conventional five-gallon plastic bucket, such that the buckets can be stacked upon one another and securely held in place wherein the crown raised lip 214 will prevent horizontal or side shifting or movement of the stacked buckets.

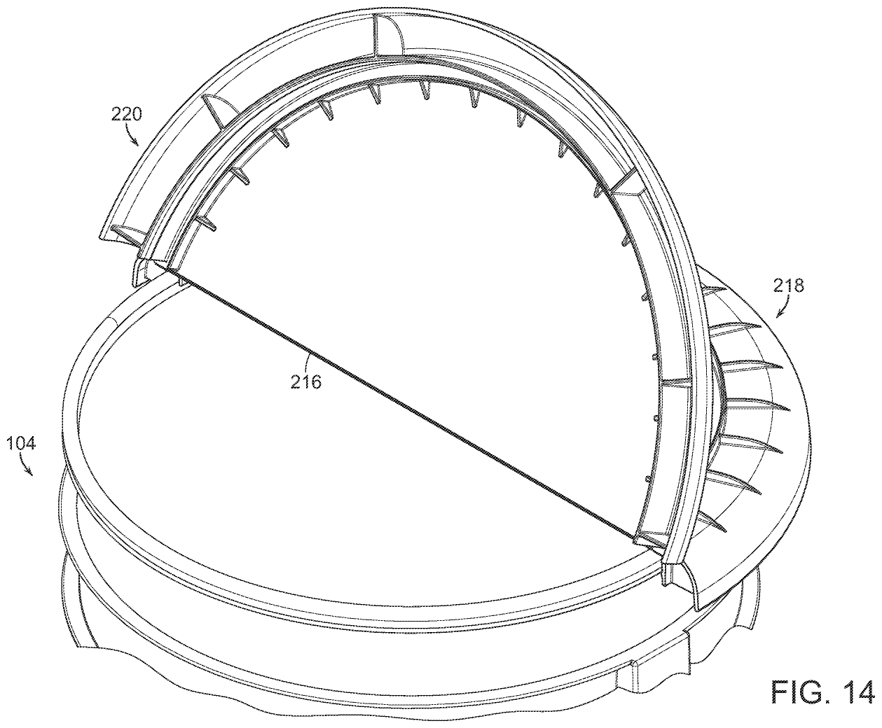

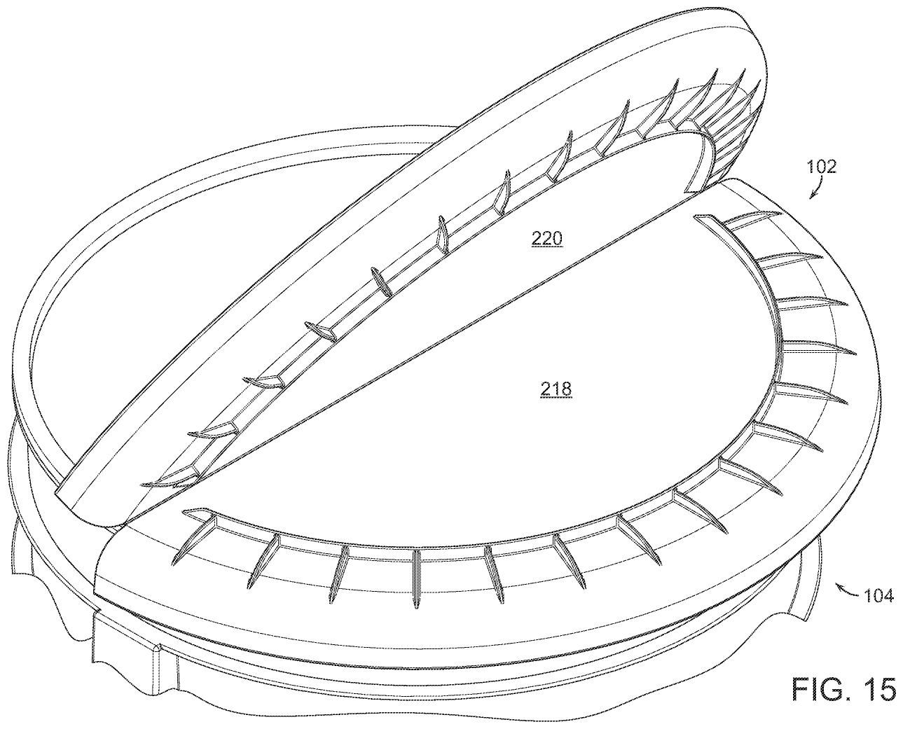

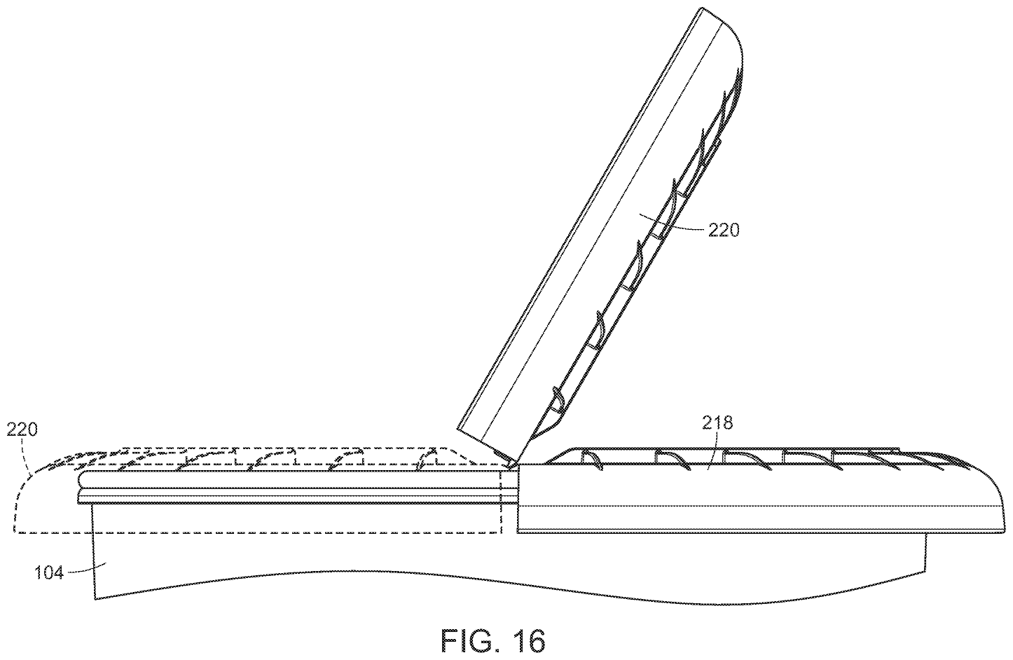

With reference now to various figures, including FIGS. 6, 7 and 13-18, the lid 102 may include a hinge 216, typically a living hinge, dividing the lid into portions 218 and 220, which enables a portion 220 of the lid 102 to be pivoted upwardly and removed from the rim of the bucket 104 while the other portion 218 remains attached to the bucket 104. This enables the user to access the interior of the bucket 104, such as to add more paint or other liquid to the bucket 104, without having to completely remove the lid 102, as illustrated in FIGS. 14-16.

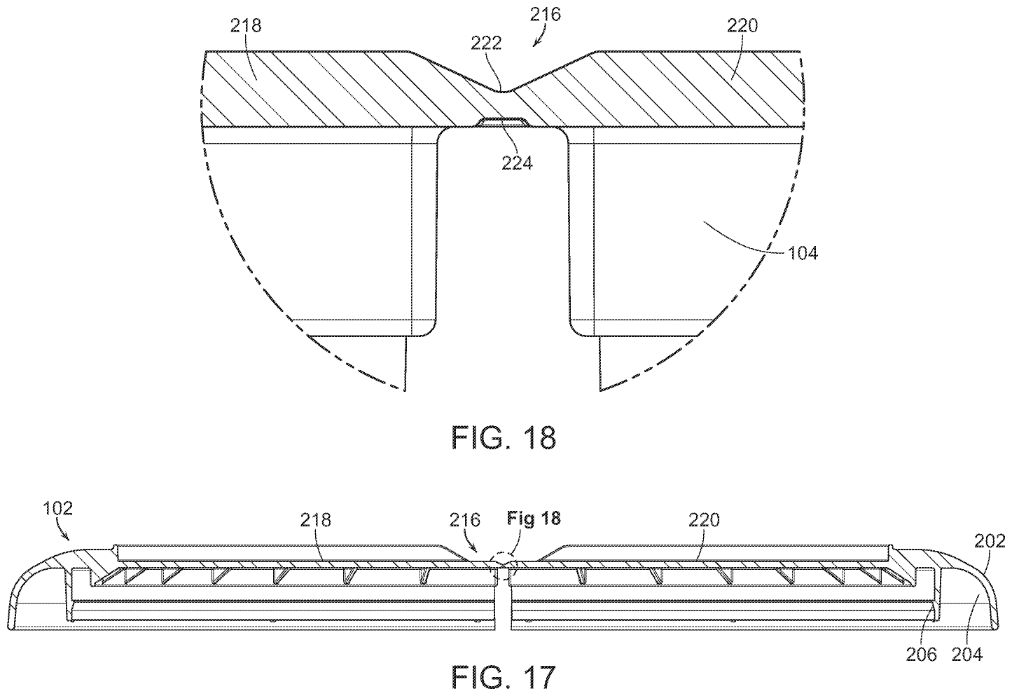

In a particularly preferred embodiment, as illustrated in FIGS. 17 and 18, the hinge 216 is a living hinge of reduced cross-sectional thickness or diameter, such as having notches 222 and 224 formed therein which provide an area of flexibility to enable the lid portions 218 and 220 to pivot relative to one another. The advantage of having a living hinge 216 is that the lid 102 still provides an air-tight and sealed structure with respect to the bucket 104. While a preferred configuration of having the hinge 216 extend generally across the mid-section of the lid 102 is illustrated, it will be understood that the hinge 216 could divide the lid 102 into sections of differing size or configuration, such as only a third of the lid being pivotable upward instead of approximately one-half of the lid, a V-shaped section, etc. However, having the hinge 216 extend across approximately the mid-section of the lid 102 so as to divide the lid 102 into roughly two equal parts has been found to provide a balance between the need to provide access to the contents of the bucket 104 while still securely maintaining the lid 102 on the bucket 104 and even maintaining a connection with an airless sprayer in an embodiment of the invention, which is illustrated and discussed more fully herein.

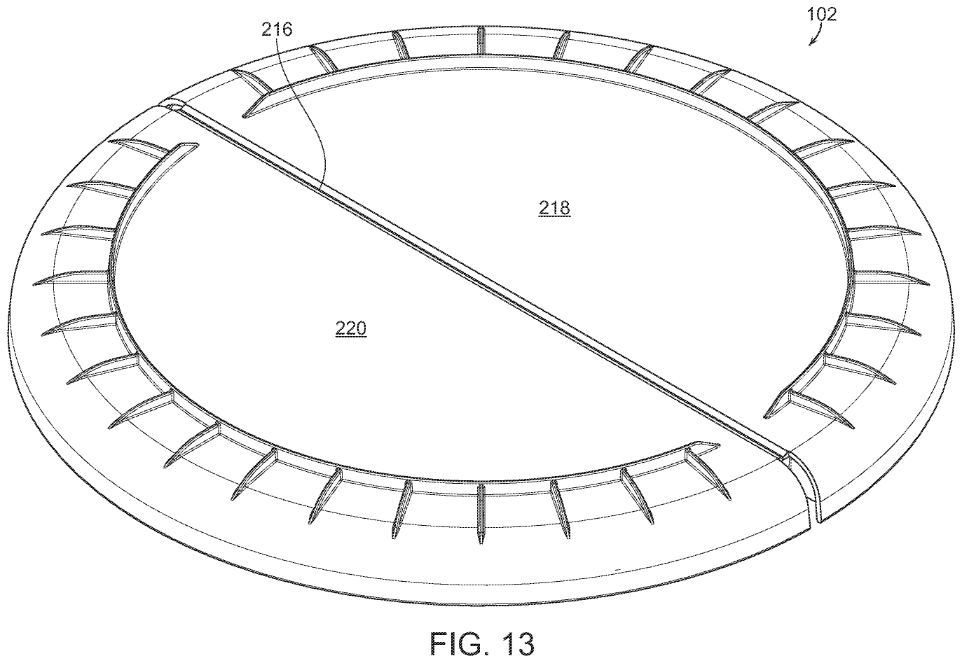

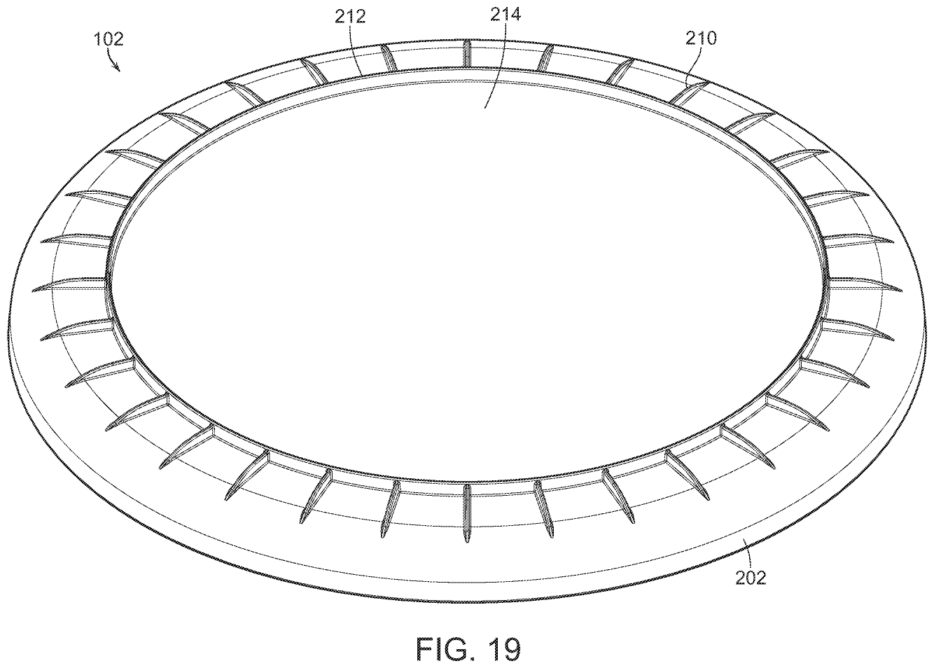

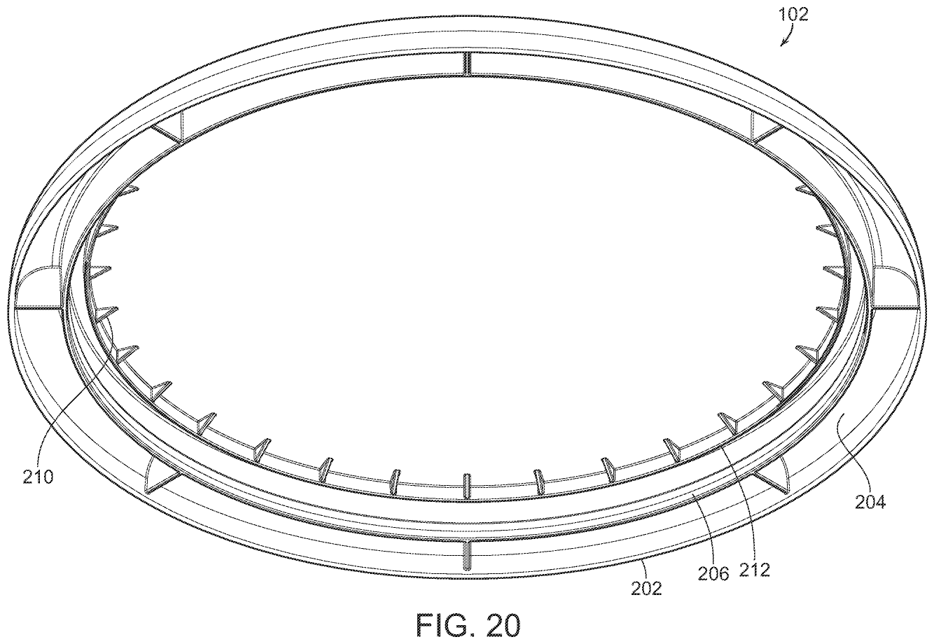

Typically, the lid 102 includes the apertures or ports 106 and 114 formed therethrough, as shown in the various figures, including FIGS. 6 and 7. These are also illustrated with the particularly preferred embodiment of incorporating the hinge 216, so as to create the two different portions 218 and 220 which can be selectively pivoted upwardly to open access to the bucket 104. Such hinges would have a similar arrangement as illustrated in FIGS. 17 and 18 and pivot upwardly, as illustrated in FIGS. 14-16. The lid illustrated in FIGS. 13-18 could be used, for example, for storage purposes when the paint dispenser assembly 108 is not in use. Incorporating the living hinge 216 into such a lid still enables the contents of the bucket 104 to be accessed. In other cases, however, as illustrated in FIGS. 19 and 20, the lid 102 may be of a solid configuration without any apertures 106 or 114 formed therethrough or a living hinge 216. In such case, such lids could be used purely for storage purposes with the lid 102 having other features including the fingerhold recesses 204, ribs 210 and crown 212, enabling stacking of buckets, as described above.

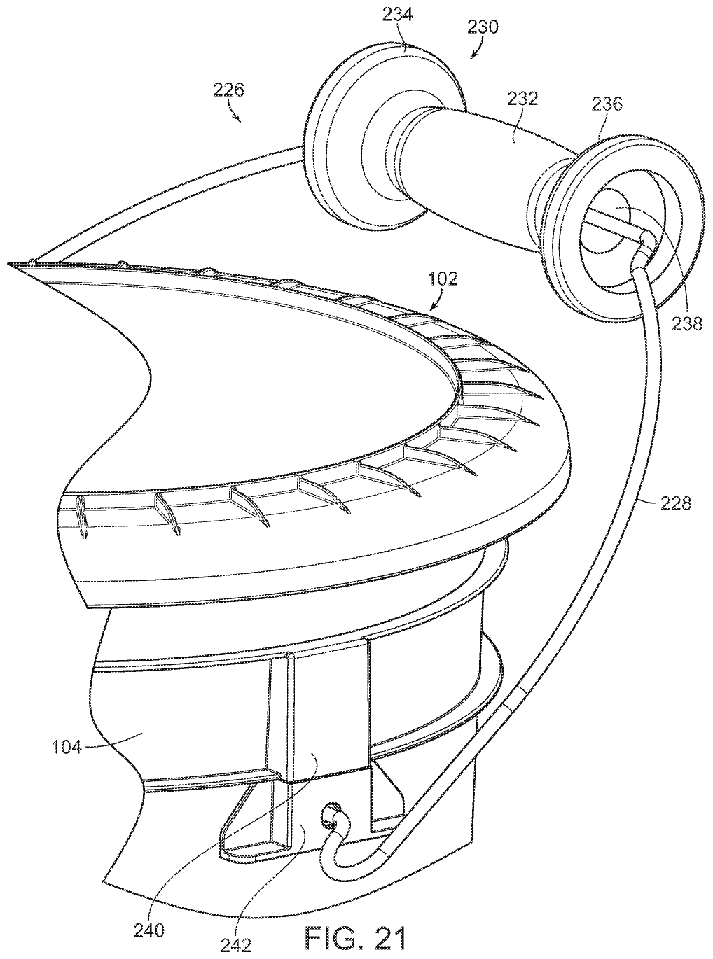

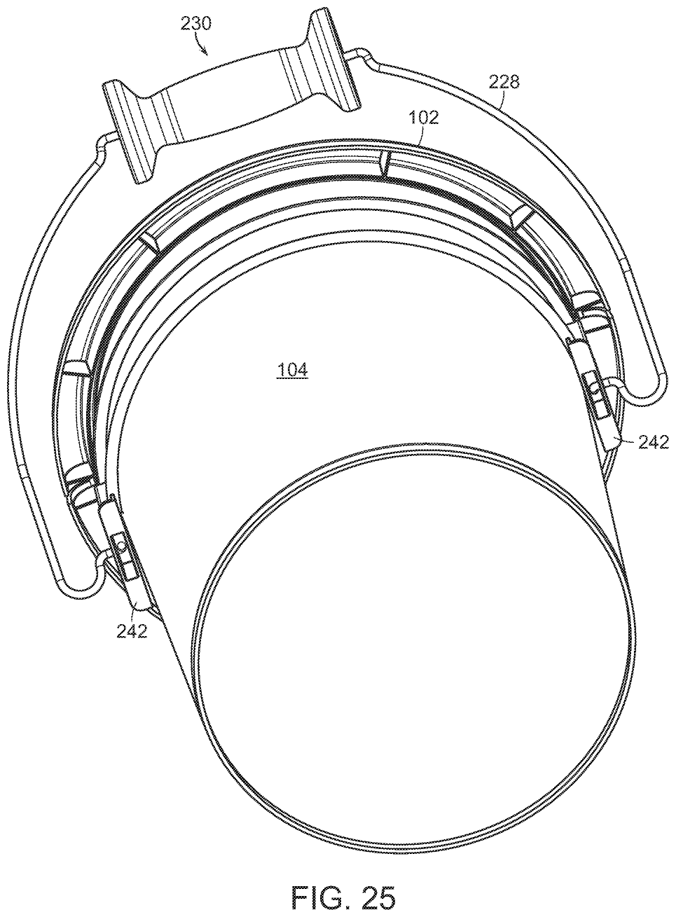

With reference now to FIGS. 21-25, conventionally, buckets, particularly five-gallon buckets and the like, have a handle comprised of a thin rod of, typically metal, which extends from the sides of the bucket in pivoting relation, to a small plastic sleeve which the user can grasp. As mentioned above, given the configuration of the sleeve and the weight of the bucket, it can be very uncomfortable to lift the bucket, and over time this could even cause injuries. Moreover, when incorporating the lid 102 of the present invention, which extends over the rim of the bucket 104, the handle which comes with the bucket 104 is not sized so as to extend over the lid 102 of the present invention. Accordingly, a revised and improved handle assembly 226 is attached to the bucket 104 which overcomes these shortcomings.

The handle assembly 226 also includes a rod 228, typically a metal rod, which is bent and configured and sized so as to extend over the lid 102 of the present invention when it is attached to the bucket 104. A larger, ergonomically-shaped grip 230, typically comprised of a plastic material or the like, is attached to the rod 228. The grip 230 of the handle assembly 226 is much larger than a traditional sleeve grip of a conventional bucket and is ergonomically shaped, such as illustrated in the figures attached hereto, including FIG. 21.

In the sleeve of a conventional five-gallon bucket handle, a user typically has to grip the sleeve with his or her fingers or place it within the palm of his or her hand as it is not large enough for the user to fully grasp with his or her hand. The relatively small nature of the conventional grip causes it to apply tremendous force and pressure to the user's fingers or hand.

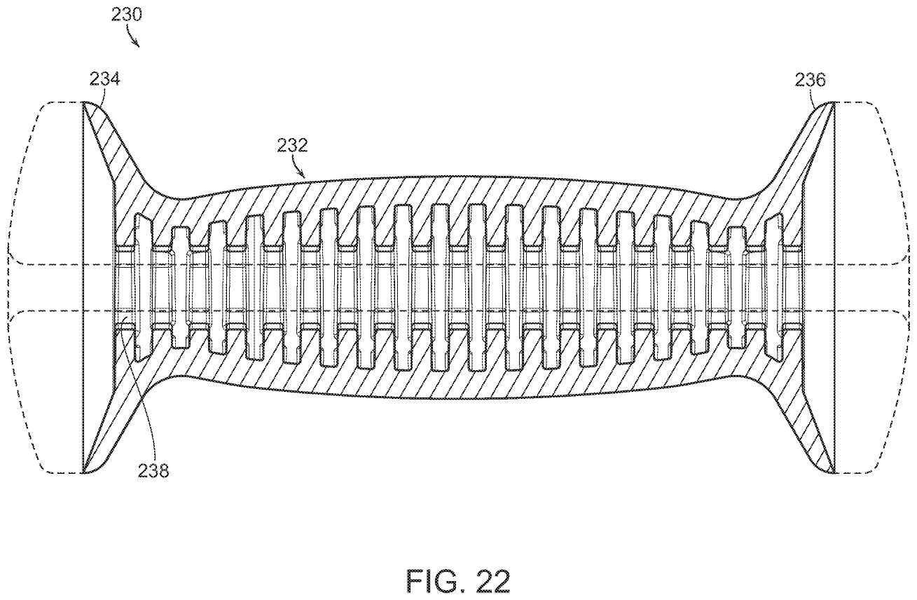

However, in accordance with the present invention, the grip 230 of the handle 226 includes a central grip portion 232 which is rounded and sized such that the user can place his entire hand over the grip portion 232 and grasp it with both the palm and at least a portion of the user's fingers. The central grip portion 232 is of a length which is sufficient such that the user can place the entirety of his or her hand thereon, and is bordered by side walls 234 and 236 which have a larger diameter than the central grip portion 232 so as to prevent the user's hands from sliding off of the central grip portion 232, and also providing side support to the user's hand such that in the palm, inner surface of the fingers, and side portions of the clenched fist around the central grip portion 232 are all in contact with the grip 230, providing support and comfort to the user when lifting the bucket 104, alleviating tension and injuries. FIG. 22 illustrates the grip 230 in cross-section, illustrating a passageway 238 formed therethrough through which the handle rod 228 can extend.

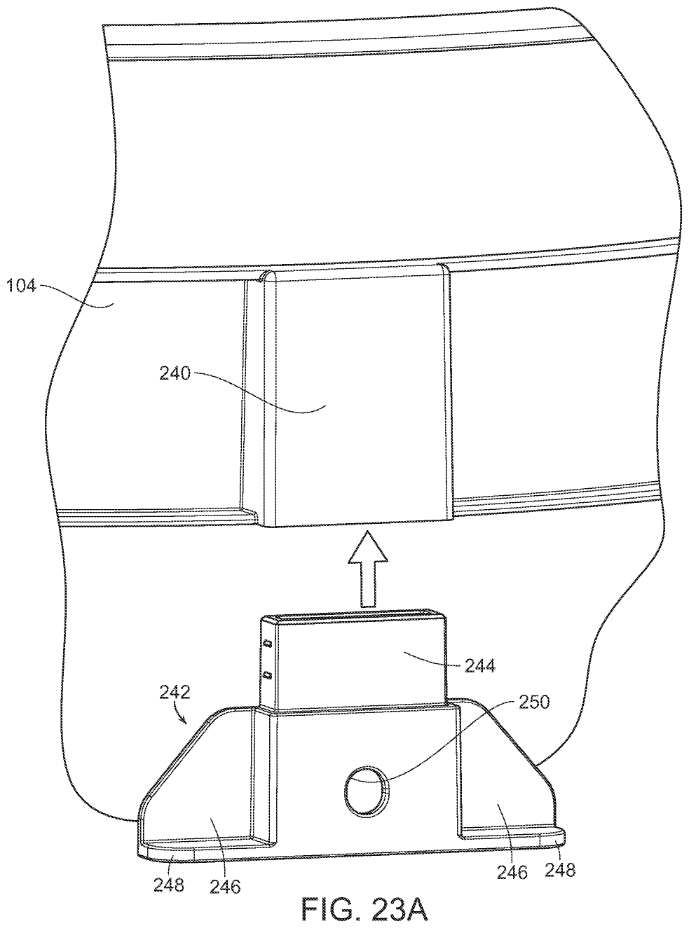

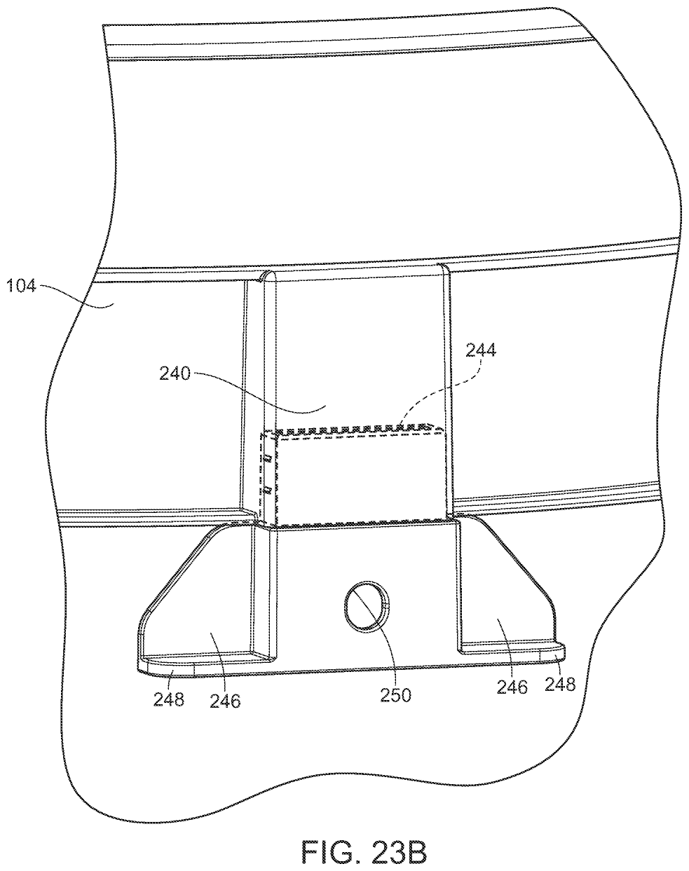

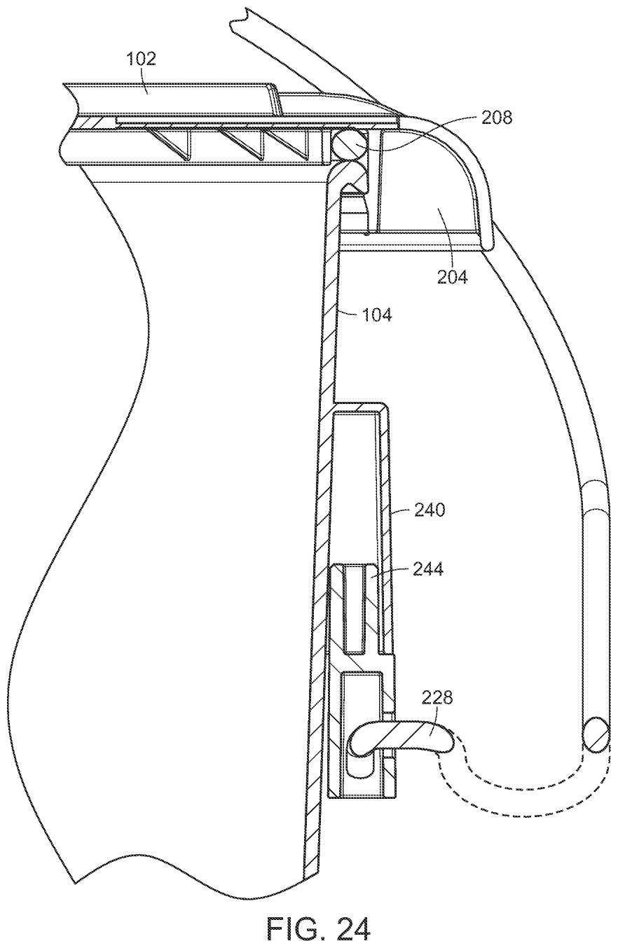

The handle assembly 226 may be retrofittedly attached to an existing bucket 104. Existing five-gallon buckets 104 include a hollow molded port 240 on each side of the bucket. The free ends of a conventional handle are typically attached to apertures formed in a side wall thereof. In accordance with the present invention, an adapter 242 is attached to each free end of the rod 228 of the handle assembly 226 which is removably insertable into the hollow port 240 of the bucket 104. This is illustrated in FIGS. 23A and 23B. A post portion 244 of the adapter 242 is sized and configured so as to be received within the hollow port 240. Wing portions 246 having ledges 248 extend outwardly and provide the user areas to grip the adapter 242 and forcibly inserting it into the hollow port 240, or conversely removing the adapter 242 from the port 240. The post 244 of the adapter 242 is sized and configured so as to be inserted with a frictional fit within the hollow port 240, as illustrated in FIG. 24. The user may push upon or pull upon ledges 248 of the wings 246 for pushing or pulling and thus inserting or removing the adapter 242. The adapter 242 includes an aperture 250 into which a free end of the rod 225 of the handle can be inserted, as illustrated in FIG. 24. As illustrated in FIG. 21, when installed, the enlarged and improved handle 226 of the present invention is able to extend over the lid 102.

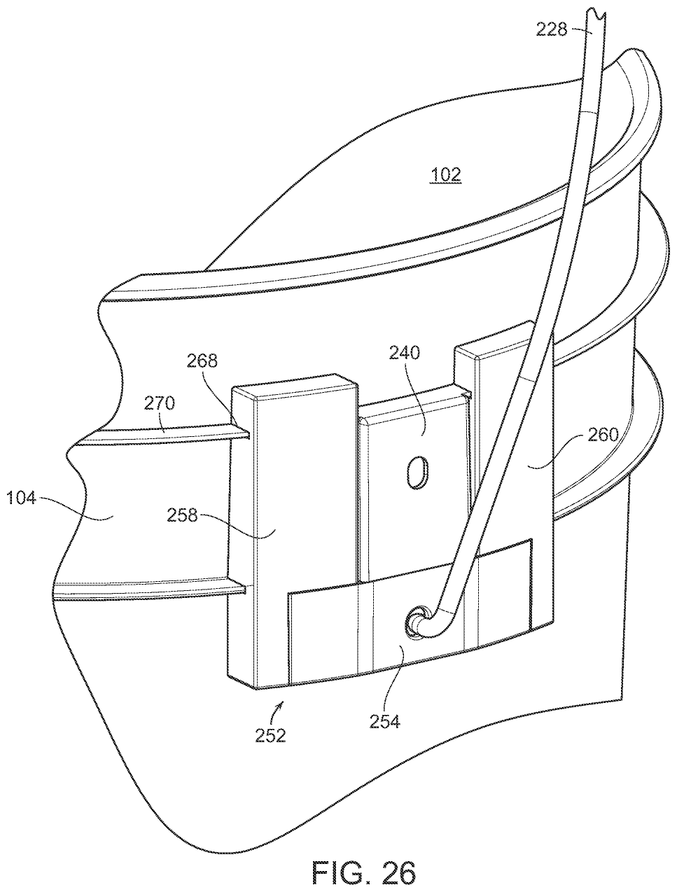

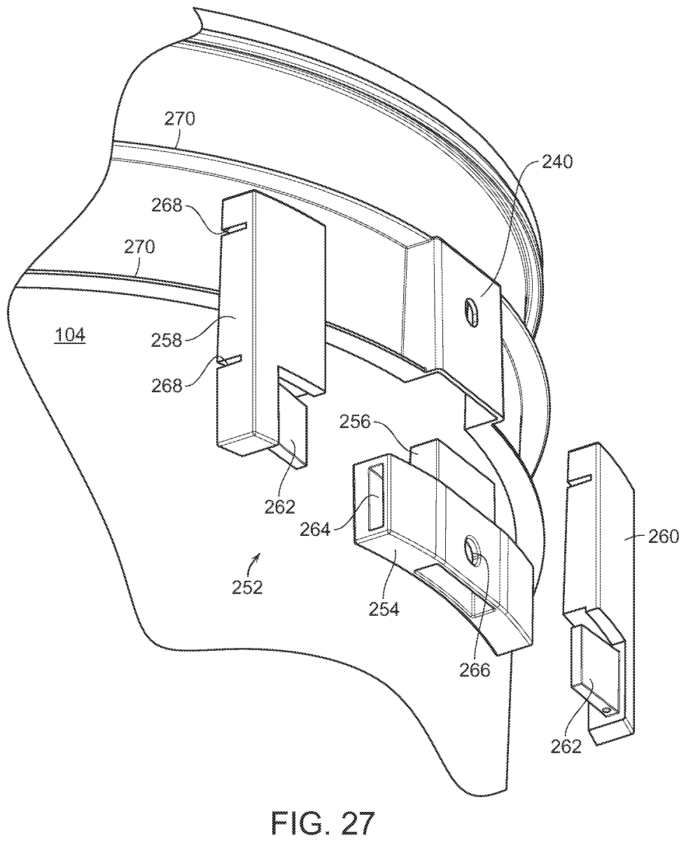

With reference now to FIGS. 26 and 27, another adapter 252 is shown which could be interconnected to the hollow port 240 of the bucket 104 and the rod 228 of the handle. FIG. 26 illustrates the adapter 252 in an assembled state and attached to the hollow port 240 and having the rod 228 inserted therein. FIG. 27 illustrates the various component parts in an exploded view. This adapter 252 has a central piece 254 with a post 256 extending therefrom sized and configured so as to be received within the bucket handle hollow port 240, similar to that described above. Two locking side members 258 and 260 are detachably connected to the central piece 254, such as by insertion of protrusions 262 into side apertures 264 of the central piece so as to lock them in place, as illustrated in FIG. 26. This is formed by a frictional fit and can be manually inserted and removed by pushing or pulling the side pieces 258 and 260 from the central piece 254. The central piece 254 also includes an aperture 266 into which an end of the handle rod 228 may be inserted, as illustrated in FIG. 26. The side pieces 250 and 260 include open channels or slots 268 formed therein which are insertable over ribs 270 to further secure the adapter 252 to the bucket 104.

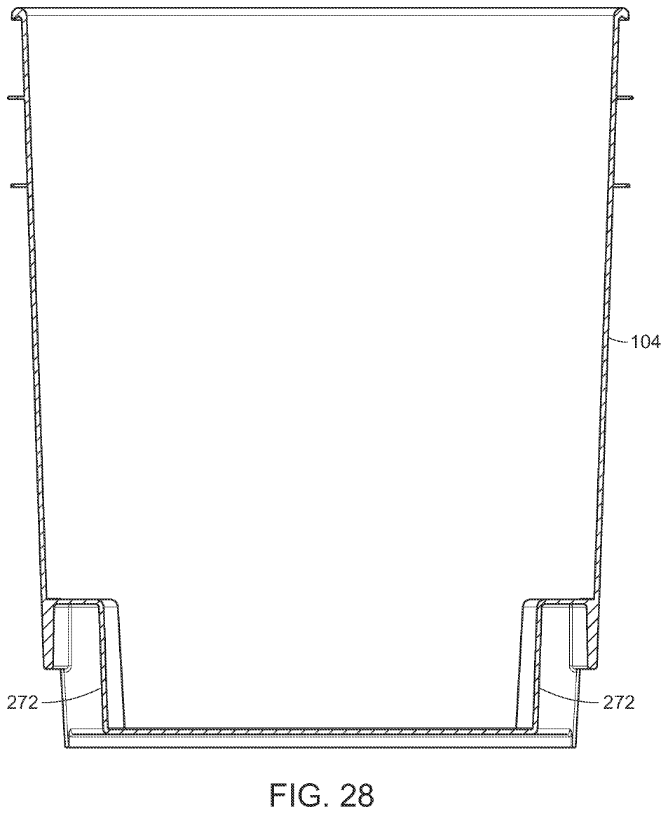

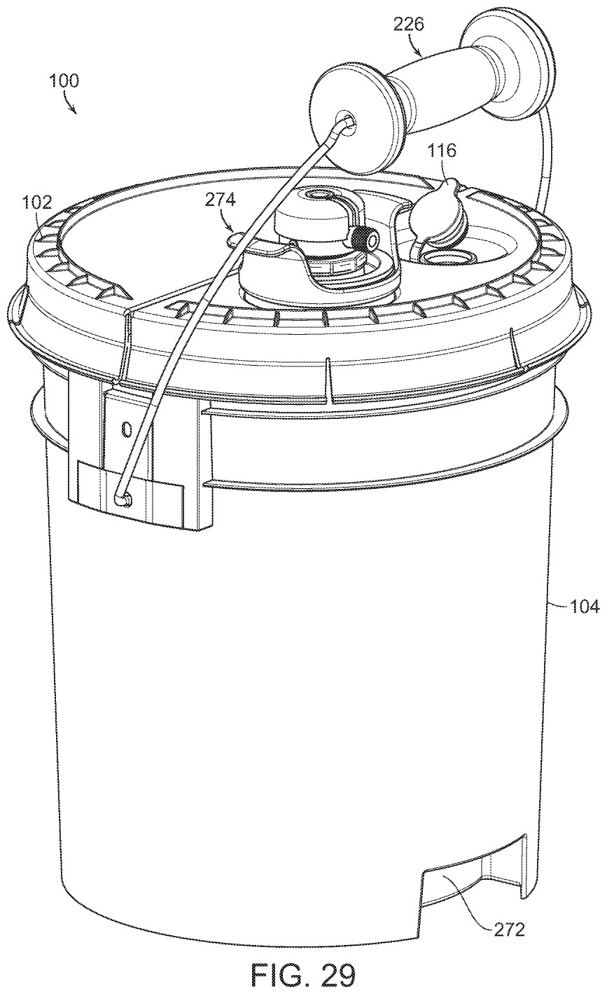

With reference now to FIGS. 28 and 29, currently buckets, particularly five-gallon buckets, have a generally coplanar bottom peripheral edge. Thus, when the bucket 104 is lying on a floor or ground surface, and the user desires to pick the bucket up when not using the handle, the user must tilt the bucket 104 slightly so as to create a space so that the user's fingers can be inserted between the ground surface and the bottom edge of the bucket 104 so as to lift the bucket. In accordance with the present invention, as illustrated in FIGS. 28 and 29, buckets 104 may be created with handhold pockets 272 which are recessed areas sufficiently large for the user to insert his or her fingers therein and lift the bucket, preferably without having to tip the bucket to one side. Such pockets 272 are molded with the bucket 104 during its manufacture and creation. Such handhold pockets 272 could also be molded within the bucket 104 within the peripheral bottom edge of the bucket, which would still assist the user in having a handhold to insert the user's fingers when picking up or carrying the bucket 104. This could assist the user in not only lifting the bucket, but also in cases where the user is holding the bucket by the handle with one hand and tipping the bucket, such as to pour its contents, with the other with the user's fingers inserted into one of the hand pockets or handholds 272.

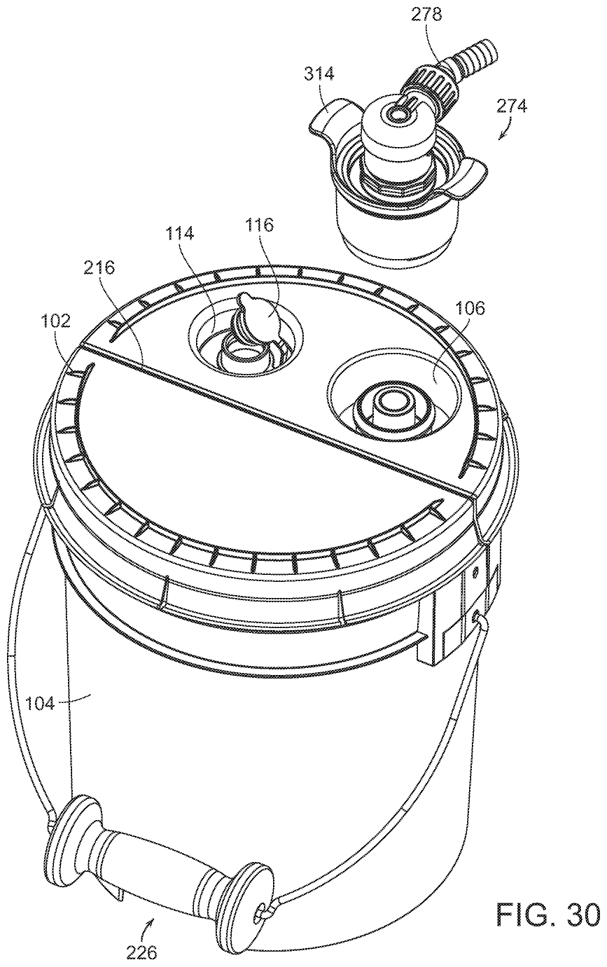

With reference now to FIGS. 29-32, a system 100 of the present invention is shown with a paint dispenser assembly which functions and operates in a very similar manner as the assembly 108 illustrated and described above, but has a different quick connect/disconnect mechanism interconnecting its upper assembly 274 and lower assembly 276. FIG. 29 illustrates the upper assembly 274 in a coupled and attached position with respect to the lower assembly 276 and the lid 102. In FIG. 30, however, the upper assembly 274 has been detached from the lower assembly. In FIG. 30, the airless sprayer hose 278 is shown attached to the upper assembly 274. The user may then move the upper assembly 274 and attach it to a lower assembly disposed in another paint bucket in a quick and easy manner.

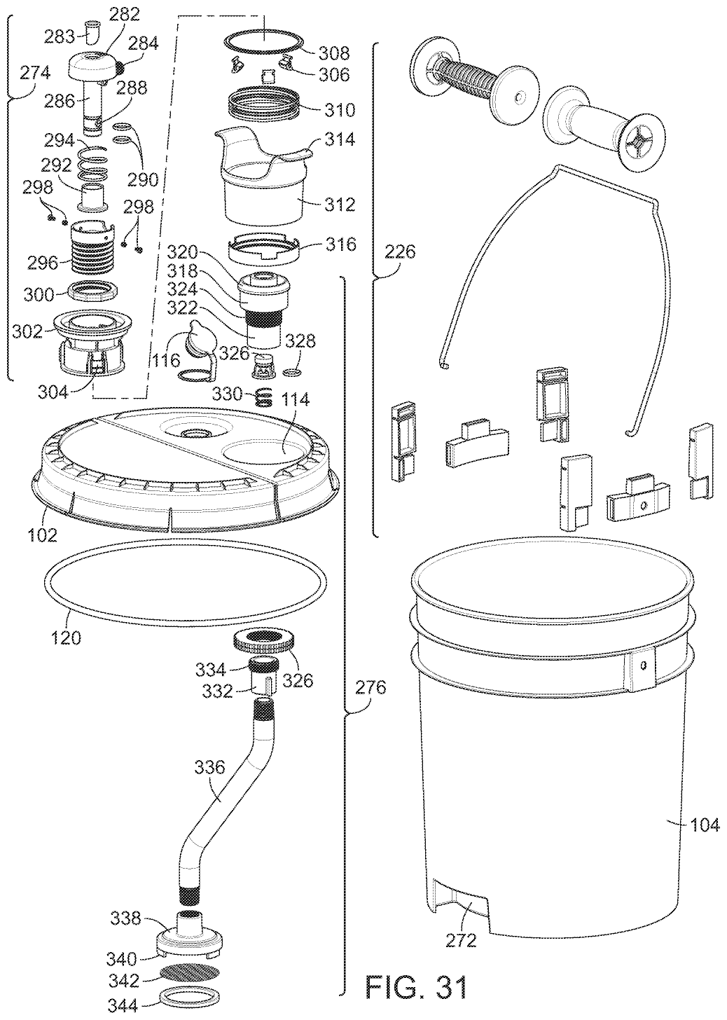

With reference now to FIG. 31, an exploded view of the various components of the system 100 is shown. The paint dispenser assembly 280, as described above, comprises an upper assembly 274 detachably coupled to a lower assembly 276, which is attached to lid 102 such that an upper portion thereof resides within aperture or port 114. A hose adapter 282 has an airless spray hose attachment end 284, which defines a fluid outlet of the dispenser 280. For manufacturing purposes, a plug 283 may be inserted into the hose adapter 282. The hose adapter 282 includes a shaft 286 extending downwardly therefrom which is hollow and in fluid communication with one or more inlets 288 formed in a side wall thereof. O-rings 290 come into sealing engagement with an interior surface of bushing 292 when the shaft 286 and bushing 292 are in their biased closed position due to spring 294. Hollow bushing 292 resides within the hose adapter body 296 and fasteners 298 attach the hose adapter body 296 to the hose adapter 282. Nut 300 may be threaded onto the external threads of the hose adapter body 296 such that the aforementioned components can be detached as a single piece, such as when cleaning or unclogging the dispenser assembly 280, as will be more fully described herein.

The hose adapter body 296 is threadedly received within the quick connect adapter 302. The quick connect adapter 302 has recessed areas which are configured to pivotally receive locks 306 therein. O-ring 308 may provide for a watertight seal. Spring 310 is disposed within quick disconnect sleeve 312 so as to surround quick disconnect adapter 302, such that the cam locks 306 are biased outwardly when the upper assembly 274 is decoupled from the lower assembly 276. The quick disconnect sleeve 312 includes upper curved members 314, which serve as fingerholds for pushing or pulling the upper assembly 274 in order to couple or decouple it from the lower assembly 276. Seal 316 provides a fluid tight seal between the upper assembly 274 and the lower assembly 276, and more particularly the quick disconnect sleeve 312 and the lid adapter body 318.

The lid adapter body 318 includes a peripheral lip or edge 320 to which the locks 306 pivot into and out of engagement with so as to couple or lock and decouple and unlock the upper assembly 274 to the lower assembly 276. The lid adapter body 318 includes a post 322 extending downwardly therefrom having threads 324 which receives nut 326 so as to attach the lid adapter body 318 to the lid 102, as illustrated and described above.

Similar to that described above, valve 326 having a sealing O-ring 328 is biased by spring 330 into a sealing engagement with a corresponding inner surface of the lid adapter body 318 when biased in its closed position. When moved away from its biased position, the valve 326 travels within pickup adapter 332 which has threads 334 which attach it to the lid adapter body at one end, and to the tube 336 at an opposite end.

At a generally opposite end of the tube 336, which may be flexible but is preferably substantially rigid, is attached a support and filter member 338 having legs 340 so as to raise the filter member 338 from the bottom surface of the bucket. A filter 342 may be disposed within the filter member 338 and held in place by a filter cover 344. The filter 342 may be used to filter contaminants or undissolved pieces of the paint or other fluid.

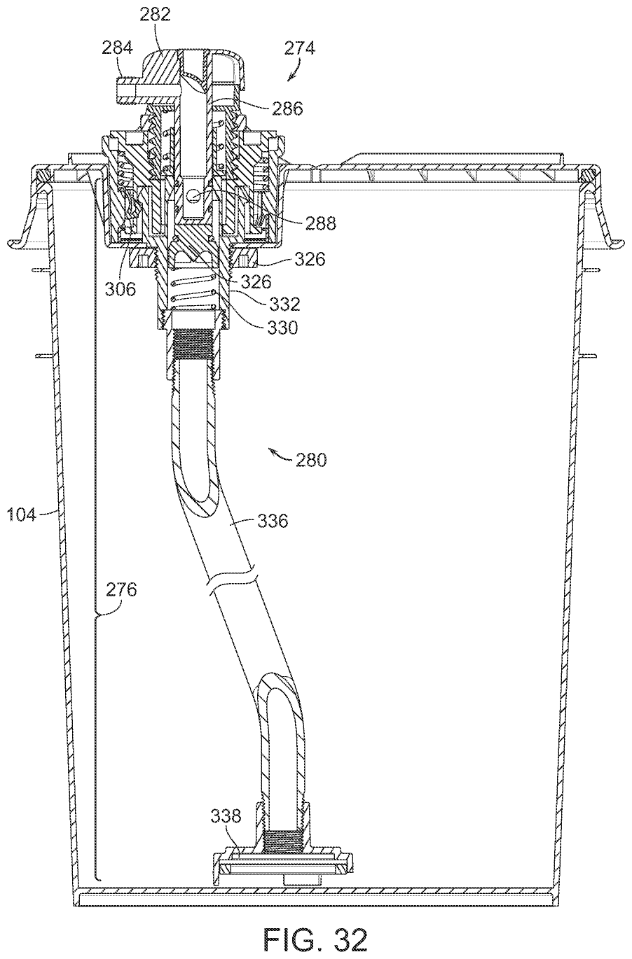

With particular reference now to FIG. 32, a cross-sectional view of the paint dispenser 280 is illustrated with the upper assembly 274 coupled to the lower assembly 276 so as to withdraw paint or other fluid from the bucket 104. Coupling of the upper assembly 274 to the lower assembly 276 causes shaft 286 to push valve 326 downwardly and into an open position such that paint or other fluid may flow through the paint dispenser from an inlet end thereof to the outlet end 284. The paint or other fluid flows around valve 326 and into shaft inlet 288 and out outlet 284, such as when a hose of an airless paint sprayer is attached thereto so as to suction and draw the paint or other fluid from the bucket 104.

In this coupled position, when the upper assembly 274 is pushed downwardly into engagement with the lid adapter body 318, the cammed locks 306 are pushed inward so as to engage lip 320 and lock the upper assembly 274 to the lower assembly 276. However, when the upper assembly 274 is removed from the lower assembly 276, such as by pulling upwardly on fingerholds 314, the locks 306 are pivoted outwardly into an unlocked position so as to decouple the upper assembly 274 from the lower assembly 276. When this occurs, valve 326 is biased upwardly into a closed position by spring 330, such that it forms a sealing engagement with the inner surface of the lid adapter body, thus sealing the lower assembly 276 and preventing paint or other fluid from exiting therefrom.

A benefit of the quick connect/disconnect mechanism illustrated and described above with respect to the embodiment in FIGS. 29-32 is that the user need not align projections within an opening of a track to couple and decouple the upper and lower assemblies of the paint dispenser. Instead, the user can position the upper assembly at any radial point and push downwardly on the upper assembly to couple it to the lower assembly and pull upwardly on fingerholds 314 to decouple it from the lower assembly, as described above.

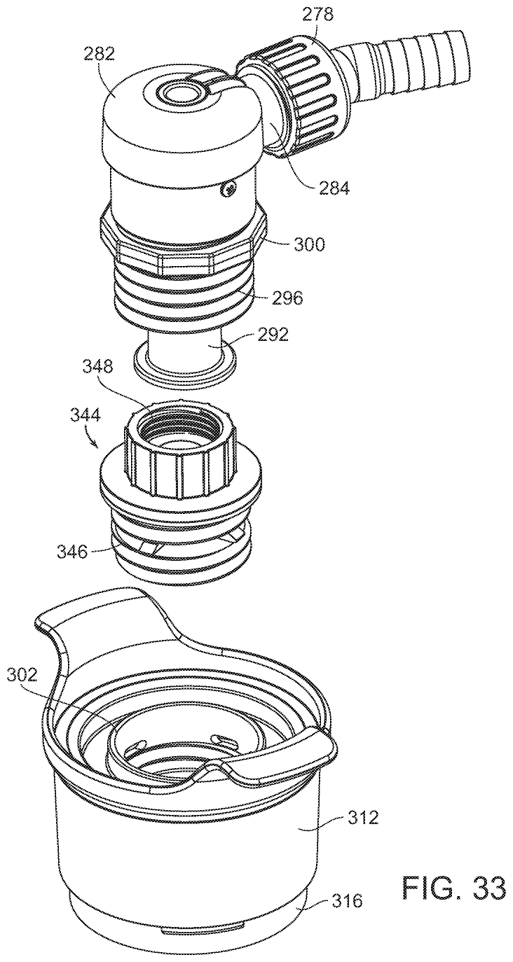

With reference now to FIG. 33, on occasion paint, stain or other fluids may clog the fluid flow pathway of the paint dispenser assembly. This may occur as the paint or other fluid comes into contact with air and dries, or for other reasons, such as if a filter is not used or the like. In such a case, a portion of the upper assembly 274 may be detachably removed from the remainder of the paint dispenser for attachment of a hose cleaner body 344. The detached portion typically includes the hose adapter 282, bushing 292 and hose adapter body 296. A lower end of the hose cleaning body 346 may be received within quick connect adapter 302, such as by threaded connection, to attach the hose cleaner body 344 to the remainder of the paint dispenser assembly. An O-ring or other seal may be provided between the hose cleaner body 344 and quick connect adapter 302 to form a fluid tight connection. An upper end 348 of the hose cleaner body 344 is configured to receive an end of a garden hose or the like, such as being internally threaded to receive the external threads of the end of the garden hose, such that a user may flush the paint dispenser 280 with water or other cleaning fluid. This could be the case when the paint dispenser 280 is clogged, or after a job and the paint dispenser 280 needs to be cleaned.

It will be appreciated by those skilled in the art that the system 100 of the present invention provides many advantages over the current systems and methodologies used in withdrawing paint or other fluid from a bucket, such as by use of an airless paint sprayer. The system of the present invention cuts both setup and cleanup times significantly. The system of the present invention allows for fast, easy and no hassle changing and storing of paints on the job. No opening and closing of buckets is even necessary. The quick release feature of detaching the upper assembly from the lower assembly of the paint dispenser allows for quick and easy universal switching from one bucket to another and also for simple disassembly and cleaning.

Although several embodiments have been described in detail for purposes of illustration, various modifications may be made without departing from the scope and spirit of the invention. Accordingly, the invention is not to be limited, except as by the appended claims.

What is claimed is:

1. A paint bucket dispensing and dripless storage system, comprising:
a lid detachably connected to a paint bucket, the lid having an aperture formed therethrough;
a paint dispenser extending through the lid aperture in sealed relation thereto such that a paint intake end of the paint dispenser is disposed within the bucket and a paint outlet end is disposed above the lid;
wherein the paint dispenser defines a paint fluid pathway between the intake end and the outlet end; and
wherein the paint outlet end is configured to be detachably connected to an inlet tube of an airless paint sprayer.

2. The system of claim 1, wherein the paint dispenser comprises an upper assembly residing above the lid and including the paint outlet end and a lower assembly including the paint intake end, the upper and lower assemblies being detachably coupled to each other.

3. The system of claim 2, including a valve disposed in the lower assembly and biased towards a closed position when the upper assembly is detached from the lower assembly to close the paint fluid pathway and prevent paint from leaking from the lower assembly and paint bucket.

4. The system of claim 3, wherein a portion of the upper assembly moves the valve into an open position when the upper assembly is coupled to the lower assembly.

5. The system of claim 2, wherein the upper assembly is detachably coupled to the lower assembly by a manually actuated quick connect/disconnect mechanism.

6. The system of claim 5, wherein the quick connect/disconnect mechanism comprises a bayonet fitting cooperatively defined by portions of the upper and lower assemblies.

7. The system of claim 5, wherein the quick connect/disconnect mechanism comprises a push lock mechanism defined by portions of the upper and lower assemblies.

8. The system of claim 7, wherein the push lock mechanism comprises locking members moved into a locked position when the upper assembly is pushed into the lower assembly and moved into an unlocked position when the upper assembly is pulled from the lower assembly.

9. The system of claim 1, wherein the lid incudes a living hinge that enables a portion of the lid to be selectively opened and closed while the lid is attached to the paint bucket.

1. The system of claim 1, wherein a peripheral lip of the lid extends outwardly a distance from an upper edge of the bucket and defines a finger hold area.

11. The system of claim 1, including an enlarged, ergonomic handle detachably connected to the bucket.

1. The system of claim 1, including a cleaning adapter connectable to at least a portion of the paint dispenser to enable a cleaning fluid to pass through the cleaning adapter and the paint fluid pathway of the paint dispenser.

1. The system of claim 1, wherein the paint bucket includes recessed handholds formed in a lower portion thereof.

1. A paint bucket dispensing and dripless storage system, comprising:
a lid detachably connected to a paint bucket, the lid having an aperture formed therethrough;
a paint dispenser extending through the lid aperture in sealed relation thereto such that a paint intake end of the paint dispenser is disposed within the bucket and a paint outlet end is disposed above the lid;
wherein the paint dispenser defines a paint fluid pathway between the intake end and the outlet end; and
wherein the paint outlet end is configured to be detachably connected to an inlet tube of an airless paint sprayer;
wherein the paint dispenser comprises an upper assembly residing above the lid and including the paint outlet end and a lower assembly including the paint intake end, the upper and lower assemblies being detachably coupled to each other;
wherein a valve is disposed in the lower assembly and biased towards a closed position when the upper assembly is detached from the lower assembly to close the paint fluid pathway and prevent paint from leaking from the lower assembly and paint bucket; and
wherein the upper assembly is detachably coupled to the lower assembly by a manually actuated quick connect/disconnect mechanism.

15. The system of claim 14, wherein a portion of the upper assembly moves the valve into an open position when the upper assembly is coupled to the lower assembly.

1. The system of claim 14, wherein the quick connect/disconnect mechanism comprises a bayonet fitting cooperatively defined by portions of the upper and lower assemblies.

1. The system of claim 14, wherein the quick connect/disconnect mechanism comprises a push lock mechanism defined by portions of the upper and lower assemblies.

1. The system of claim 17, wherein the push lock mechanism comprises locking members moved into a locked position when the upper assembly is pushed into the lower assembly and moved into an unlocked position when the upper assembly is pulled from the lower assembly.

1. The system of claim 14, wherein the lid incudes a living hinge that enables a portion of the lid to be selectively opened and closed while the lid is attached to the paint bucket.

20. The system of claim 14, wherein a peripheral lip of the lid extends outwardly a distance from an upper edge of the bucket and defines a finger hold area.

21. The system of claim 14, including an enlarged, ergonomic handle detachably connected to the bucket.

22. The system of claim 14, including a cleaning adapter connectable to at least a portion of the paint dispenser to enable a cleaning fluid to pass through the cleaning adapter and the paint fluid pathway of the paint dispenser.

23. The system of claim 14, wherein the paint bucket includes recessed handholds formed in a lower portion thereof.
